(19) United States
(12) Patent Application Publication
(10) Pub. No.: US 2019/0087466 A1
(43) Pub. Date: Mar. 21, 2019

(54) SYSTEM AND METHOD FOR UTILIZING MEMORY EFFICIENT DATA STRUCTURES FOR EMOJI SUGGESTIONS

(71) Applicant: MZ IP Holdings, LLC, Palo Alto, CA (US)

(72) Inventors: Pidong Wang, Mountain View, CA (US); Shivasankari Kannan, Sunnyvale, CA (US); Nikhil Bojja, Mountain View, CA (US)

(21) Appl. No.: 16/135,478

(22) Filed: Sep. 19, 2018

Related U.S. Application Data
(60) Provisional application No. 62/561,314, filed on Sep. 21, 2017.

(51) Int. Cl. G06F 17/30; G06F 3/0482; G06F 3/0481; G06F 17/27; G06F 9/451

(52) U.S. Cl. CPC G06F 17/30528; G06F 3/0482; G06F 3/04817; G06F 17/30554; G06F 17/30327; G06F 9/451; G06F 17/2735

(57) ABSTRACT

Implementations of the present disclosure are directed to a method, a system, and an article for suggesting emojis in electronic communication. An example method can include: providing a trie data structure on a client device, the trie data structure storing a dictionary and including a plurality of nodes, wherein at least one node in the trie data structure includes a children array including at least one of: an integer index for identifying a child node; and an array size corresponding to a number of child nodes for the at least one node; and detecting, by the client device, at least one character entered by a user in a user interface of the client device; identifying, using the trie data structure, at least one emoji corresponding to the at least one character; and presenting the at least one emoji in the user interface for user selection.

### CROSS-REFERENCE TO RELATED APPLICATIONS

This application claims the benefit of U.S. Provisional Patent Application No. 62/561,314, filed Sep. 21, 2017, the entire contents of which are incorporated by reference herein.

### BACKGROUND

The present disclosure relates to systems and methods for suggesting emojis in electronic communication and, more specifically, systems and methods for suggesting emojis in electronic communication using memory-efficient data structures.

Emojis can be images, symbols, or icons that are used in text fields in electronic communication to express emotions, succinctly convey information, or communicate a message. The use of emojis is becoming increasingly popular, especially on mobile devices (e.g., smartphones, tablets, smartwatches, etc.). Specifically, emojis are often used in electronic communication and on the Internet in media such as text messaging, email, instant messaging, social media, browser add-ins, etc. to convey emotions in place of text or to accompany text.

However, emojis can occupy a lot of random-access memory (RAM). One key limitation of some mobile devices is relatively little RAM compared to laptop and desktop computers. Laptop computers typically have 4-16 GB of RAM and desktop computers typically have even larger RAM than laptops. However, smartphones typically have about 2-8 GBs of RAM. For example, the iPhone 7 has only 2 GB of RAM.

### SUMMARY

In electronic communications such as text messaging, a user of the text messaging may want to replace a word in text with an emoji. However, the act of selecting a desired emoji from a bank of emojis can be time consuming and prone to indecision by the user. To increase the efficiency of the user experience, a software application or web browser supporting the text messaging can suggest emojis to the user as the user types messages. As discussed above, however, emojis can occupy a significant amount of memory in an electronic device, thereby slowing down conventional emoji suggestion techniques.

Disclosed herein are systems and methods for suggesting emojis in electronic communication using memory-efficient data structures. Specifically, the systems and methods disclosed herein can optimize software programs for mobile devices by reducing memory usage. In some embodiments, the systems and methods can optimize a trie data structure to reduce memory usage for an exemplary emoji mapping dictionary from about 57 MB to about 0.5 MB. Thus, the inventive data structure is highly memory-efficient for emoji suggestion on mobile devices, while preserving the lookup efficiency of the trie data structure.

In certain examples, the optimized trie data structure can use or include an improved reference portion or children array for identifying the child nodes of a parent node. The improved children array can utilize or include, for example, integer indices to identify the child nodes. Use of integer indices can reduce storage requirements for the trie data structure by a factor of 2, a factor of 4, a factor of 10, or more. Alternatively or additionally, a sparsity of the children array can be reduced or eliminated, so that the children array has few or no zero elements. In certain implementations, sparsity of the children array can be measured by the number of null pointers in the children array. The reduction in sparsity can depend on the particular emoji dictionary in the trie data structure. For example, sparsity can be reduced by 80% to 90%. In preferred implementations, for example, the children array for a node is reduced in size to include or correspond to one element or cell per child node. For example, an array size for a children array in a node can be equal to or correspond to a number of child nodes for the node. This elimination or reduction in sparsity can further reduce storage requirements for the trie data structure by a factor of 10, a factor of 30, a factor of 100, or more. Such optimizations can greatly improve the efficiency with which the systems and methods described herein are able to provide emojis suggestions. The reduced storage requirements, for example, can allow the emojis suggestions to be determined directly on a client device, without having to call a server to obtain the suggestions. Additionally or alternatively, the improved storage efficiency can reduce computation times for suggesting emoji by a factor of 2, a factor of 10, a factor of 100, or more.

Although the present invention has been described in the context of emoji suggestion, the present invention is broadly applicable to any other suitable application where such a memory-efficient data structure can be used to save memory. For purposes of illustration and not limitation, the auto completion bar of the Apple iOS keyboard can benefit from the present invention. For example, when an incomplete word or phrase is typed, the iOS keyboard can suggest complete words or phrases, in addition to or instead of emojis, using the techniques described herein. Another example is a recommendation system that can suggest, for example, products or services according to what a user has started to type. Other appropriate applications of the present invention are possible.

In one aspect, the subject matter described in this specification relates to a memory-efficient computer-implemented method for suggesting emojis in electronic communication. The method includes: providing a trie data structure on a client device, the trie data structure storing a dictionary and including a plurality of nodes, wherein at least one node in the trie data structure includes a children array including at least one of: an integer index for identifying a child node; and/or an array size corresponding to a number of child nodes for the at least one node; and detecting, by the client device, at least one character entered by a user in a user interface of the client device; identifying, using the trie data structure, at least one emoji corresponding to the at least one character; and presenting the at least one emoji in the user interface for user selection.

In certain examples, the children array includes the integer index for identifying the child node. The children array can include a plurality of cells, and the cells can include a plurality of integer indices identifying a plurality of child nodes. The children array can include the array size corresponding to the number of child nodes for the at least one node. The children array can include at least one pointer for identifying at least one child node. The children array can include the integer index for identifying the child node. Identifying the at least one emoji can include: selecting a child node corresponding to the at least one character; and determining that the child node includes at the least one emoji. Selecting the child node can include: detecting, by the client device, at least one additional character entered in the user interface; and advancing from a parent node to the child node based on the at least one additional character.

In some implementations, the at least one character can form a prefix to at least two words, and identifying the at least one emoji can include: determining at least two child nodes, of the trie data structure, corresponding to the at least two words, each node of the at least two child nodes including a corresponding emoji list; and compiling two or more emojis from the corresponding emoji lists to define the at least one emoji. The method can include: receiving a user selection of an emoji from the at least one emoji; and presenting the selected emoji on the user interface.

In another aspect, the subject matter described in this specification relates to a system for suggesting emojis in electronic communication. The system includes one or more computer processors programmed to perform operations including providing a trie data structure on a client device, the trie data structure storing a dictionary and including a plurality of nodes, wherein at least one node in the trie data structure includes a children array including at least one of: an integer index for identifying a child node; and/or an array size corresponding to a number of child nodes for the at least one node; and detecting, by the client device, at least one character entered by a user in a user interface of the client device; identifying, using the trie data structure, at least one emoji corresponding to the at least one character; and presenting the at least one emoji in the user interface for user selection.

In certain examples, the children array includes the integer index for identifying the child node. The children array can include a plurality of cells, and the cells can include a plurality of integer indices identifying a plurality of child nodes. The children array can include the array size corresponding to the number of child nodes for the at least one node. The children array can include the integer index for identifying the child node.

In some implementations, identifying the at least one emoji can include: selecting a child node corresponding to the at least one character; and determining that the child node includes at the least one emoji. Selecting the child node can include: detecting, by the client device, at least one additional character entered in the user interface; and advancing from a parent node to the child node based on the at least one additional character. The at least one character can form a prefix to at least two words, and identifying the at least one emoji can include: determining at least two child nodes, of the trie data structure, corresponding to the at least two words, each node of the at least two child nodes including a corresponding emoji list; and compiling two or more emojis from the corresponding emoji lists to define the at least one emoji. The operations can include receiving a user selection of an emoji from the at least one emoji; and presenting the selected emoji on the user interface.

In another aspect, the subject matter described in this specification relates to an article for suggesting emojis in electronic communication. The article can include a non-transitory computer-readable medium having instructions stored thereon that, when executed by one or more computer processors, cause the computer processors to perform operations including: providing a trie data structure on a client device, the trie data structure storing a dictionary and including a plurality of nodes, wherein at least one node in the trie data structure includes a children array including at least one of: an integer index for identifying a child node; and/or an array size corresponding to a number of child nodes for the at least one node; and detecting, by the client device, at least one character entered by a user in a user interface of the client device; identifying, using the trie data structure, at least one emoji corresponding to the at least one character; and presenting the at least one emoji in the user interface for user selection.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims.

### BRIEF DESCRIPTION OF THE DRAWINGS

FIG. 1 is a schematic diagram of an example system for suggesting emojis using memory-efficient data structures.

FIGS. 2A-2B are schematic diagrams of an example trie data structure having pointers for navigating the structure.

FIG. 3 is a schematic diagram of an example trie data structure having integer indices for navigating the structure.

FIG. 4 is a flowchart of an example method for suggesting emojis using a trie data structure.

FIG. 5 is a flowchart of an example method for suggesting emojis using a trie data structure having pointers for navigating the structure.

FIG. 6 is a flowchart of an example method for suggesting emojis using a trie data structure having integer indices for navigating the structure.

FIG. 7 is a schematic diagram of an example trie data structure having dynamic children arrays for navigating the structure.

FIG. 8 is a flowchart of an example method for suggesting emojis using a trie data structure.

### DETAILED DESCRIPTION

In various implementations, the subject matter of this disclosure relates to the use of memory-efficient data structures to suggest emojis in electronic communication. The exemplary systems and methods can suggest emojis as users are inputting characters (e.g., by typing, speaking, etc.), for example, by relying on data structures storing one or more dictionaries. For example, the dictionary-based emoji suggestion method can use a dictionary that maps words or phrases (e.g., a term or groups of two or more words) to a list of emojis. Thus, in this way, the phrase “lol” can be mapped to “ [symbol] ” (a smiley-face emoji). The dictionary can be constructed manually and/or developed through the use of crowdsourcing, which can be incentivized. Some exemplary dictionary implementations can include less than 1,000 emoji. Other implementations can include greater than 1,000 emojis (e.g., up to about 5,000 emojis, up to about 10,000 emojis, etc.). Note that an emoji can correspond to a single word or a group of two or more words. In some cases, an emoji cannot correspond to any word.

In an exemplary system, the basic unit of data used in the dictionary is a word mapped to a list of emojis that can replace the word. Examples collecting word-to-emoji(s) mappings can be found in commonly owned U.S. Patent Application Publication No. 2013/0159919, published Jun. 20, 2013, U.S. Pat. No. 9,043,196, issued May 26, 2015, and U.S. Patent Application Publication No. 2017/0185581, published Jun. 29, 2017, the entire disclosures of which are incorporated by reference herein. In some embodiments, a model file having the word-to-emoji(s) mappings can be stored in memories of server systems and synchronized with, or accessed by, client devices, e.g., smartphones, tablets, laptops, etc.

In an exemplary implementation, to suggest one or more emojis as a user of an electronic device is typing a word, each character and/or keystroke can be detected to suggest emoji(s). Such functionality can provide an emoji suggestion(s) for every keystroke. Making a server call for each of these suggestions, however, can result in too many requests and can incur network lag. Hence, for the purposes of retrieving data to suggest emojis, it is generally much faster to avoid server calls and/or store the dictionary in memory on the client device. Storing this dictionary in an efficient manner on mobile client devices is a primary objective of the systems and methods described herein, particularly for client devices having significant memory constraints.

In the various implementations described herein, memory-efficient data structures include trie data structures and/or data structures having trie properties. Other ways of organizing data, such hash data structures or lists of sorted words, can be implemented and used by the exemplary methods and systems to suggest emojis. A hash map data structure, for example, can be configured to store prefixes (e.g., portions of words) that can be associated with one or more emojis. Each prefix can be associated with a link to a list of emojis that can be suggested for the prefix. However, while the lookup of words is very fast, the storing of a significant amount of data and the mapping of the data structure can require a large amount of memory. In another example, a list of sorted words can be used by the exemplary methods and systems to suggest emojis, in which each word in the list is linked to a list of emojis. This method can have the advantage of being simple in execution; however, the method can require longer time to look up each word. Additionally, the list of sorted words can store all the characters of each word, which can require significant memory resources.

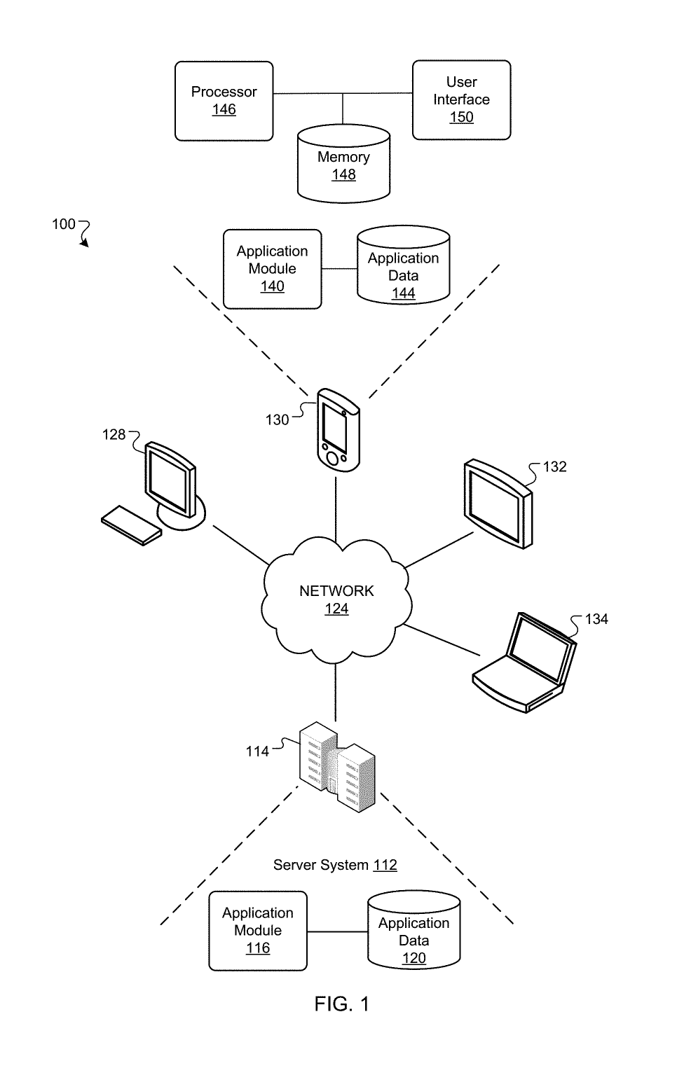

FIG. 1 illustrates an example system 100 for suggesting emojis using memory-efficient data structures. A server system 112 provides functionality for providing data structures that efficiently utilize memory on client devices. The server system 112 includes software components and databases that can be deployed at one or more data centers 114 in one or more geographical locations, for example. The server system 112 software components can include an application module 116 and/or can include subcomponents that can execute on the same or on different individual data processing apparatus. The server system 112 databases can include an application data 120 database. The databases can reside in one or more physical storage systems. The software components and data will be further described below.

An application, such as, for example, a web-based or other software application can be provided as an end-user application to allow users to interact with the server system 112. The application can include a messaging application (via short message service (SMS), multimedia message service (MMS), etc.), web-based application, a browser add-in, etc. The software application or components thereof can be accessed through a network 124 (e.g., the Internet) by users of client devices, such as a personal computer 128, a smart phone 130, a tablet computer 132, and a laptop computer 134. Other client devices are possible. In alternative examples, the data structures used by the messaging application, or any portions thereof, can be stored on one or more client devices. Additionally or alternatively, software components for system 100 or any portions thereof can reside on or be used to perform operations on one or more client devices.

Each client device in the system 100 can utilize or include software components and databases for the software application. The software components on the client devices can include an application module 140, which can implement the software application on each client device. The databases on the client devices can include an application data 144 database, which can store data for the software application and exchange the data with the application module 140. The data stored on the application data 144 database can include, for example, data structures (e.g., trie data structures), emojis, one or more dictionaries, etc. While the application module 140 and the application data 144 database are depicted as being associated with the smart phone 130, it is understood that other client devices (e.g., the smart phone 130, the personal computer 128, the tablet computer 132, and/or the laptop computer 134) can include the application module 140, the application data 144 database, and any portions thereof. Each client device 128, 130, 132, 134 can include interconnected components such as one or more processors 146, one or more memory units 148, and a user interface 150. These interconnected components can be in communication with the application module 140 and/or the application data 144 database.

In certain implementations, a trie data structure (or data structure having trie properties) can be used by the exemplary methods and systems to suggest emojis. A trie (taken from the word “retrieval” and pronounced “try” to distinguish it from other tree structures) data structure can be a tree-like data structure configured to store a string-based dictionary. The trie data structure, for example, can be a prefix-optimized data structure that can be useful for storing string-based dictionaries on mobile client devices, as explained in greater detail herein. Advantageously, the trie data structure can optimize memory usage, for example, in terms of a number of bytes stored for strings. In other words, the trie data structure can utilize less memory, compared to other data structures, such as the hash data structure or the list of sorted words.

By using a trie data structure, an amount of memory used for suggesting emojis can be optimized, and the efficiency with which a computer carries out general tasks, parallelized tasks, or specific task for suggesting emojis can be improved. This is particularly helpful in mobile client devices that, as discussed above, are more constrained by the available amount of RAM. Thus, although other suitable data structures can be used with the present invention, the following disclosure describing the exemplary methods and systems focuses on utilizing a trie data structure for suggesting emojis, as the approach provides greater savings in memory-utilization.

The trie data structure is or includes, for example, a prefix-optimized tree data structure that is constructed over each element of a string. The elements can be or include, for example, bytes, characters, etc. In a preferred structure, words that share a common prefix can follow the same tree branch, which provides a first level of memory efficiency. For example, the words “chair” and “champagne” share the prefix “cha.” In some implementations, trie data structures are highly memory-efficient for obtaining words starting with a given prefix. For example, one or more computer processors can receive an incomplete word (e.g., the prefix “cha”) from a user utilizing a messaging application. The processor then can access the trie data structure to retrieve a list of possible emojis (e.g., chair emoji, champagne emoji, chandelier emoji, etc.) for the given prefix.

In the following implementations, a trie data structure stores at least one string-based dictionary. For example, the trie data structure can store characters in American Standard Code for Information Interchange (ASCII) values (e.g., 0 to 127) or a subset of ASCII values (e.g., 65 to 90 for uppercase English characters and 97 to 122 for lowercase English characters). The trie data structure preferably has a plurality of nodes organized as a tree with a common root node. The common root node can be empty.

In an exemplary implementation, each node of the trie data structure can include the following elements:
i. Children array: A portion of each node configured to store reference values for identifying child nodes or connecting a first node (e.g., a parent node) to a second node (e.g., a child node). As discussed below, the reference values can be or include a pointer array configured to point to a child node or an integer index configured to store the locations for the child node.
ii. Emoji list portion: A portion of each node configured to store a list of emojis having at least one emoji if the string ending with the current node is a word end or a prefix. Otherwise, the portion is empty.

In any of the implementations disclosed herein, each node of the trie data structure can further include:

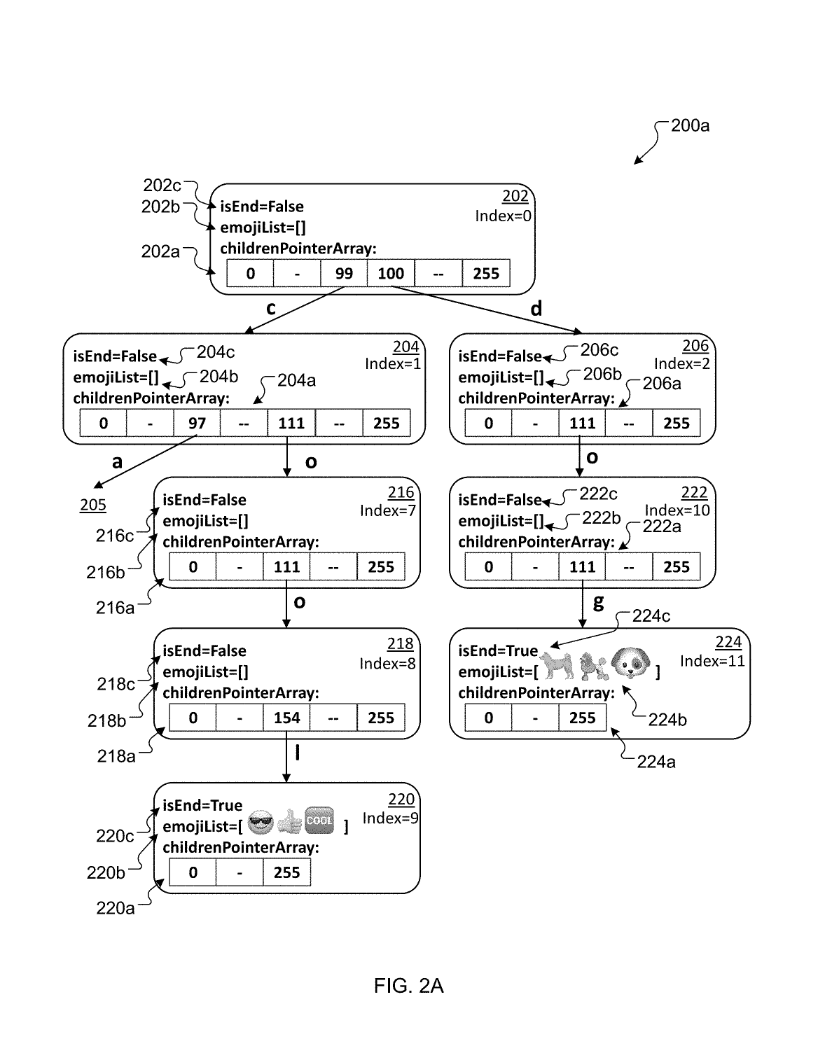

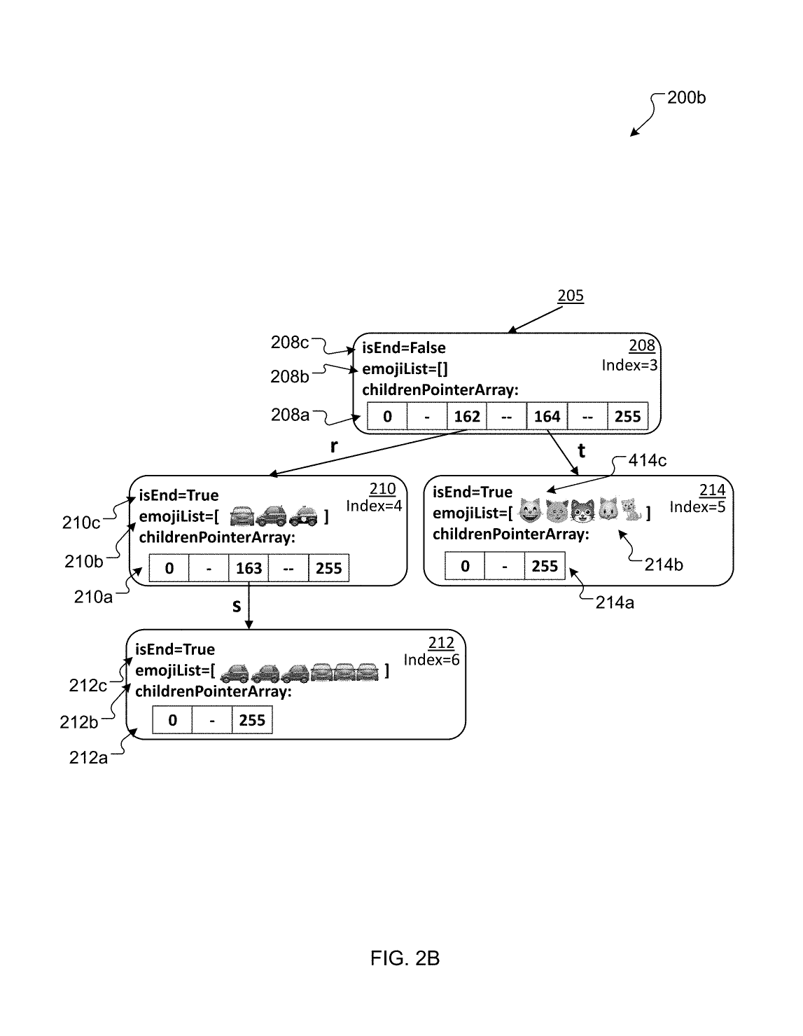

iii. Word-end indicator: A portion of each node configured to store an indicator having a Boolean value that indicates whether the current node is a word or prefix end. For example, in FIGS. 2A, 2B, 3, and 7, the word-end indicator in each node is labelled “isEnd.” If the current node corresponds to a word end, “isEnd” equals “True.” If the current node does not correspond to a word end, “isEnd” equals “False.”

In some implementations, referring to FIGS. 2A and 2B, when the user enters characters that form a complete word or phrase but the user continues entering additional characters, the preceding characters (e.g., “car”) can become a prefix to a new complete word or phrase (e.g., “cars,” “career,” “carbon,” “carry on,” etc.). Accordingly, the processor 146 can traverse through a subtree rooted at the current node (e.g., node 210 for “car”) to find other complete words that share the prefix. If, for example, the user enters the character “s” after “car,” the pointer with ASCII value 163 for “s” can point to an appropriate child node (e.g., node 212). If, at node 212, the word-end indicator “isEnd” equals “True” and at least one emoji is available in the emoji list portion (e.g., “emojiList”), the at least one emoji can be presented to the user.

In some implementations, the exemplary system can treat any entered character or characters as a prefix. Thus, in this example, before the user types the character “s,” the processor can scan the trie data structure to identify any words for which “car” is a prefix. If such words exist, then the processor can combine the emoji list for those words with the emoji list for the word “car.” This merged emoji list can then be presented to the user via the user interface 150.

In some implementations, a trie data structure is received by the client device 128, 130, 132, 134. In some examples, the client device can receive at least a partial, or whole, trie data structure from server system 112 via a network 124 (over an Ethernet, Wi-Fi, or other connection). Once received, the partial or whole trie data structure can be stored by a memory of the client device (e.g., in the application data 144 database). In some implementations, once the messaging application is initialized on a client device, the trie data structure can be accessed by the processor 146. In other implementations, the trie data structure is accessed upon detecting a first character entered by the user in the user interface 150 of the client device. In yet other implementations, the trie data structure can be accessed at any time. This can be particularly useful if the trie data structure is used in communication via a web browser or a persistent messaging application.

In an exemplary implementation, a trie data structure 200a, 200b uses pointers at each node to point to the node's children. Such a trie data structure 200a, 200b can have nodes that each include the following elements:
i. childrenPointerArray: A children array having a static array of pointers (e.g., 8 bytes typically) that contains pointers pointing to the node's children. In the present implementation, the size of the array of pointers is 256 for the number of values that one byte can represent. The childrenPointerArray can be referred to herein as a children array. In the exemplary structure of FIGS. 2A-2B, node 202 has a children array 202a, node 204 has a children array 204a, and so on (e.g., nodes 206-224 have children arrays 206a-224a, respectively).
ii. emojiList: An emoji list portion having at least one emoji when the string ending with the current node is an end of a word, a phrase, or a prefix. Otherwise, the element can be empty. In the exemplary structure of FIGS. 2A-2B, node 202 has an emoji list portion 202b, node 204 has an emoji list portion 204b, and so on (e.g., nodes 206-224 have emoji list portions 206b-224b, respectively).

In this exemplary implementation, each node of the trie data structure 200a, 200b can further include:
iii. Word-end indicator: A portion of each node configured to store an indicator having a Boolean value that indicates whether the current node is an end of a word, a phrase, or a prefix. For example, in FIGS. 2A-2B, the word-end indicator in each node is labelled “isEnd.” When the current node corresponds to a word end, “isEnd” equals “True.” When the current node does not correspond to a word end, “isEnd” equals “False.” In some implementations, the word-end indicator can indicate whether a word is a “valid” word. A “valid” word for a trie data structure can be any word or phrase that is stored in the trie data structure or identified as a complete word in the trie data structure. In the exemplary structure of FIGS. 2A-2B, node 202 has a word-end indicator 202c, node 204 has a word-end indicator 204c, and so on (e.g., nodes 206-224 have word-end indicators 206c-224c, respectively).

FIGS. 2A-2B illustrate the exemplary trie data structure 200a, 200b, respectively, having pointers. Note that the trie data structure 200a, 200b is intended to illustrate concepts described herein with a small and simple set of words that is not intended to be limiting. Note also that the trie structure 200a, 200b is split over FIGS. 2A-2B for clarity. In particular, node 204 is connected to node 208 by connection 205. Thus, if the character “a” is detected, the ASCII value of “a” (i.e., 97) in the children array 204a of node 204 in trie data structure 200a leads to node 208 in trie data structure 200b of FIG. 2B. Many other words and nodes can be used, for any desired set of emojis.

In the example trie data structure 200a, 200b, because “c” or “d” is not a valid word having a corresponding emoji, the word-end indicator “isEnd” 204b and 206b value equals “False” in nodes 204 and 206, respectively. Once a subsequent character is detected by the client device, the ASCII value of that character can be used to determine the next child node. In the example trie data structure 200a, 200b, if the character “a” is entered after “c,” then the cell having value “97” in the children array 204a of pointers connects to child node 208. Again, node 208 indicates that this is not a valid word (e.g., word-end indicator “isEnd” 208c equals “False”). If the character “r” is detected after “a,” the cell having the value “162” in the children array 208a of pointers connects to child node 210. At node 210, the entered characters form the word “car” and the word-end indicator “isEnd” 210c equals “True,” indicating that an emoji list (e.g., a selection of car-shaped emojis) is available for presentation and user selection.

In some instances, a large number of bytes can be required to store the children array of pointers in each node of the trie data structure, which can cause certain memory inefficiencies. For example, pointers programmed in the C++ programming language can take 8 bytes (or 64 bits) of memory. Such pointers can be, for example, double-precision floating point values.

Advantageously, in certain examples, the number of bytes can be reduced with the use of integer indices, which require less storage space than pointers programmed in C++ or similar high-precision values. The reduction of storage can be beneficial in instances where the integers are shorter than the C++ or high-precision pointers in terms of bytes, which is generally the case with the systems and methods described herein. Each index of a children array of integer indices can require 2 bytes (as compared to 8 bytes used by a pointer). Each byte stored in a node can be inserted into a larger static array having a trie property. In one implementation, switching from 64-bit pointers to 16-bit integer indices reduced the memory required for storing an emoji mapping dictionary from 57 MB to 15 MB.

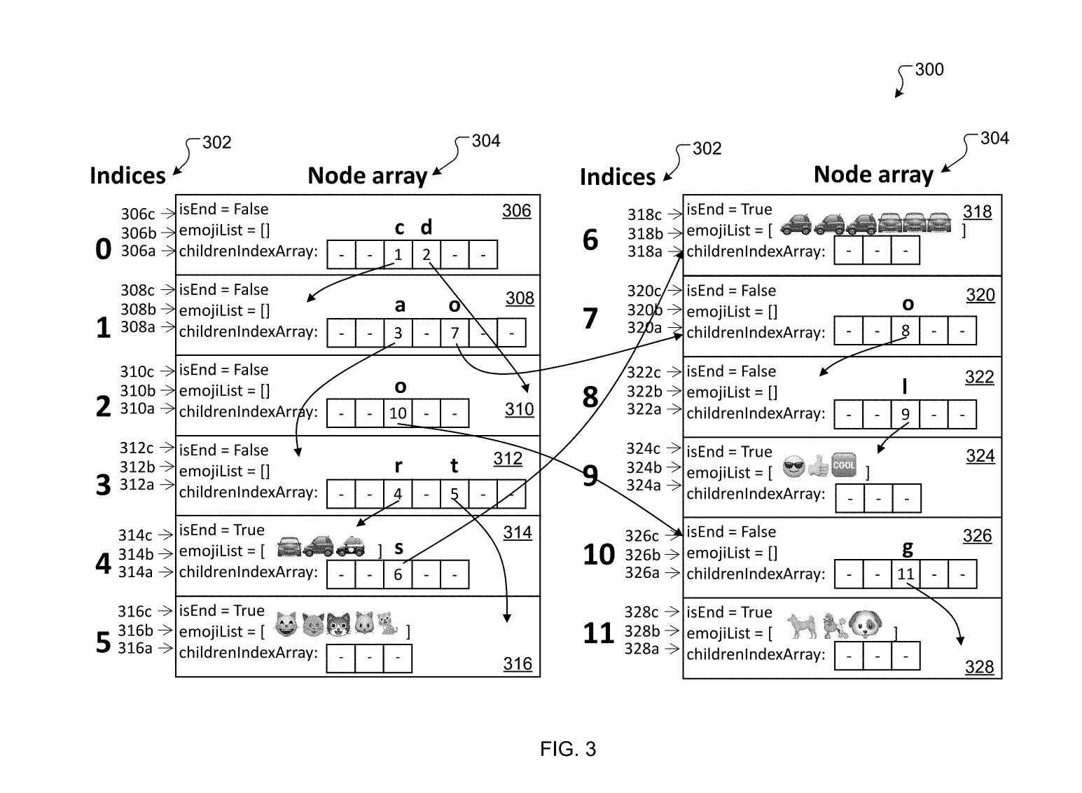

FIG. 3 illustrates an exemplary trie data structure 300 having a children array of integer indices. Note that the trie data structure 300 is intended to illustrate concepts described herein with a small and simple set of words and is not intended to be limiting. Many other words, nodes, and indices can be used, for any desired set of emojis. The children array of indices in structure 300 can be determined by indexing the trie data structure 200a, 200b, shown in FIG. 2A-2B, respectively, such that each node in the structure 200a, 200b is assigned an index in the structure 300. In the present implementation, indexing of structure 200a, 200b starts with the root node 202, which is assigned index=0 in the structure 300. Indexing then proceeds down one level or tier of nodes in the structure 200a, 200b and moves across the level of nodes, from left to right. With this approach, child node 204 is indexed at 1 and child node 206 is indexed at 2, in the structure 300. Indexing then proceeds down another level to child node 208 (index=3), down again to child node 210 (index=4), and then across to child node 214 (index=5). Next, indexing proceeds down to child node 212 (index=6). The rest of the structure 300 is indexed as follows: child node 216 is assigned index=7, child node 218 is assigned index=8, child node 220 is assigned index=9, child node 222 is assigned index=10, and child node 224 is assigned index=11. In some implementations, indexing of some or all of the nodes can be flexible and/or randomly assigned. Other ways of assigning the indexes to the nodes are possible. The structure 300 can then be organized or sorted serially (e.g., top to bottom, left to right, etc.) by indices 302 of parent nodes (e.g., in a left-hand column). In the example depicted in FIG. 3, a node array 304 includes child nodes 306 to 328, which each include indices of child nodes, as mapped to trie data structure 200a, 200b. For example, parent node with index 3 maps to child nodes with indexes 4 and 5.

Thus, in an exemplary implementation, each node of the trie data structure 300 can include the following elements:
i. childrenIndexArray: A children array having a static array of integer indices. Each index of the array can require 2 bytes (16 bits). In an exemplary implementation, the size of the array of integer indices is 256. The childrenIndexArray can be referred to herein as a children array. In the exemplary structure of FIG. 3, node 306 has a children array 306a, node 308 has a children array 308a, and so on (e.g., nodes 310-328 have children arrays 310a-328a, respectively).
ii. emojiList: An emoji list portion having at least one emoji if the string ending with the current node corresponds to a word end or a prefix. In the exemplary structure of FIG. 3, node 306 has an emoji list portion 306b, node 308 has an emoji list portion 308b, and so on (e.g., nodes 310-328 have emoji list portions 310b-328b, respectively).

In this exemplary implementation, each node of the trie data structure 300 can further include:
iii. Word-end indicator: A portion of the node configured to store an indicator having a Boolean value that indicates whether the current node corresponds to a word end. In the exemplary structure of FIG. 3, node 306 has a word-end indicator 306c, node 308 has a word-end indicator 308c, and so on (e.g., nodes 310-328 have word-end indicators 310c-328c, respectively).

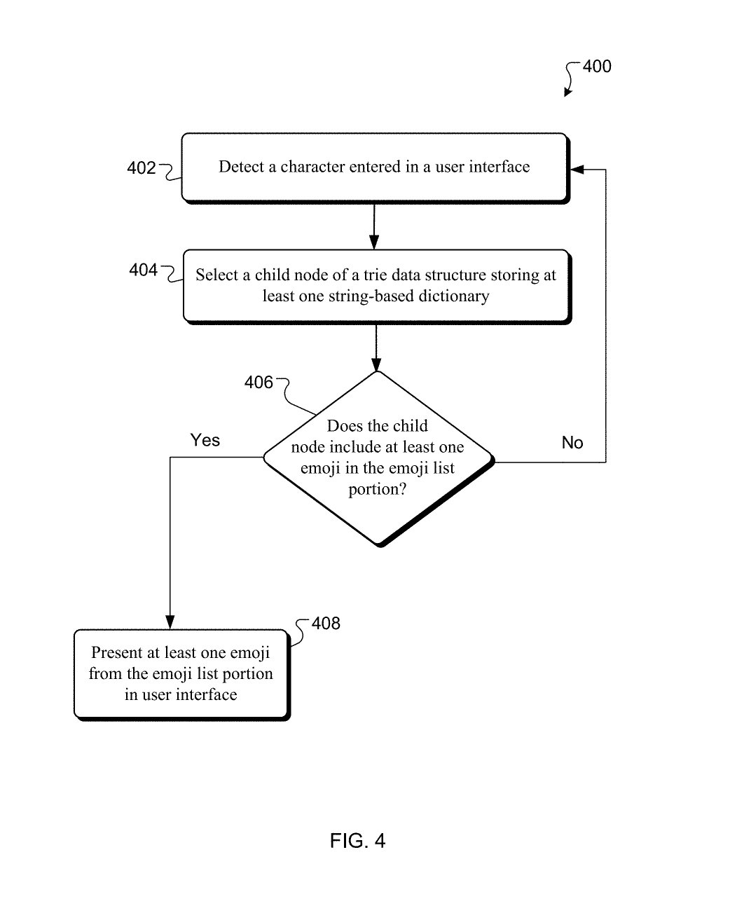

FIG. 4 is a flowchart of an exemplary method 400 for suggesting emojis using a trie data structure. In step 402, the client device 128, 130, 132, or 134 detects one or more characters entered by a user in a user interface 150 of a client device. The user interface 150 can be part of a messaging application (e.g., Messages in an iOS device, WhatsApp, etc.), a web browser, a browser add-in, etc. The character(s) can be entered by a human user or a machine user (e.g., an artificially-intelligent computer). In step 404, a first child node, of a root node, of the trie data structure can be selected by processor 146 based on a reference value corresponding to the character(s). In decision point 406, processor 146 determines whether the emoji list portion includes at least one emoji. In general, the emoji list portion can include at least one emoji when the one or more characters entered by the user form a complete word or phrase (e.g., “isEnd” equals “True”). If the emoji list portion of the child node includes at least one emoji, then in step 408, the emoji can be presented in the user interface 150. If, at decision point 406, the emoji list portion does not include at least one emoji, the method 400 can return to step 402 and the client device can detect another character entered in the user interface 150. Thus, with each additional character entry, the processor 146 can select at least one additional child node in the trie data structure. Note that each additional child node is connected, directly or indirectly, to a previous child node in the trie data structure. In this way, a position in the trie data structure advances farther from the root node with each additional detected character. When the emoji list portion of the additional child node includes at least one emoji, then the at least one emoji can be presented in the user interface 150 at step 408.

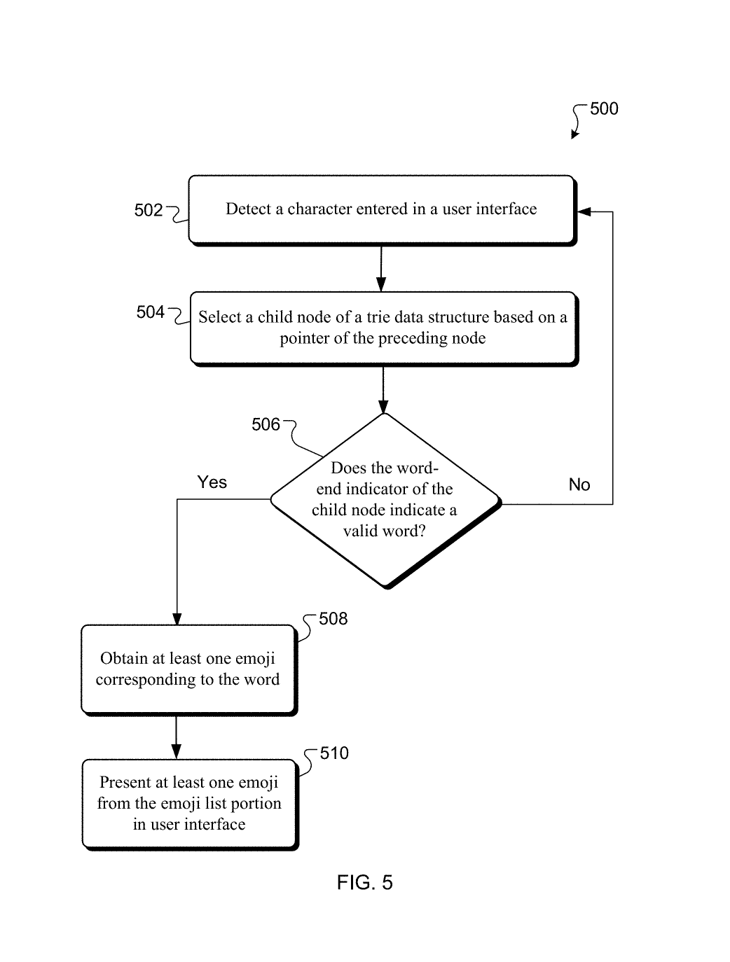

FIG. 5 is a flowchart of an exemplary method 500 for suggesting emojis using trie data structures having pointers, such as the trie data structures 200a and 200b. For ease of discussion, FIGS. 2A-2B and 5 are discussed together in the following. In step 502, the client device 128, 130, 132, or 134 detects one or more characters entered by a user in a user interface 150 of the client device. In step 504, a processor 146 of the client device selects a first child node of a root node 202 of a trie data structure 200a, 200b storing a string-based dictionary. In the example depicted in FIGS. 2A-2B, the trie data structure 200a, 200b stores the words “car,” “cars,” “cat,” “cool,” and “dog.” The exemplary root node 202 uses ASCII values of characters to point to child nodes. If the character “c” is detected in the user interface 150, for example, the ASCII value of “c” (i.e., 99) can be used as the pointer in children array 202a to find child node 204. Likewise, if an initial character “d” is detected, the ASCII value of “d” (i.e., 100) can be used as the pointer in children array 202a to find child node 206.

In step 506, the processor 146 determines whether a string formed by the one or more characters corresponds to a complete or valid word or phrase based on the value of the word-end indicator “isEnd.” If, in step 508, the stored value of word-end indicator “isEnd” in the child node equals “False,” indicating that the string is not a valid word or phrase, the method 500 can return to step 502. In step 502, the client device can detect at least one additional character entered in the user interface 150. If another character is detected, then steps 504 and 506 can be repeated. If, at step 506, “isEnd” equals “True,” then, in step 508, a corresponding list of emojis (stored in “emojiList”) can be obtained in the child node. In step 510, the list of emojis can be presented in the user interface 150 for possible user selection.

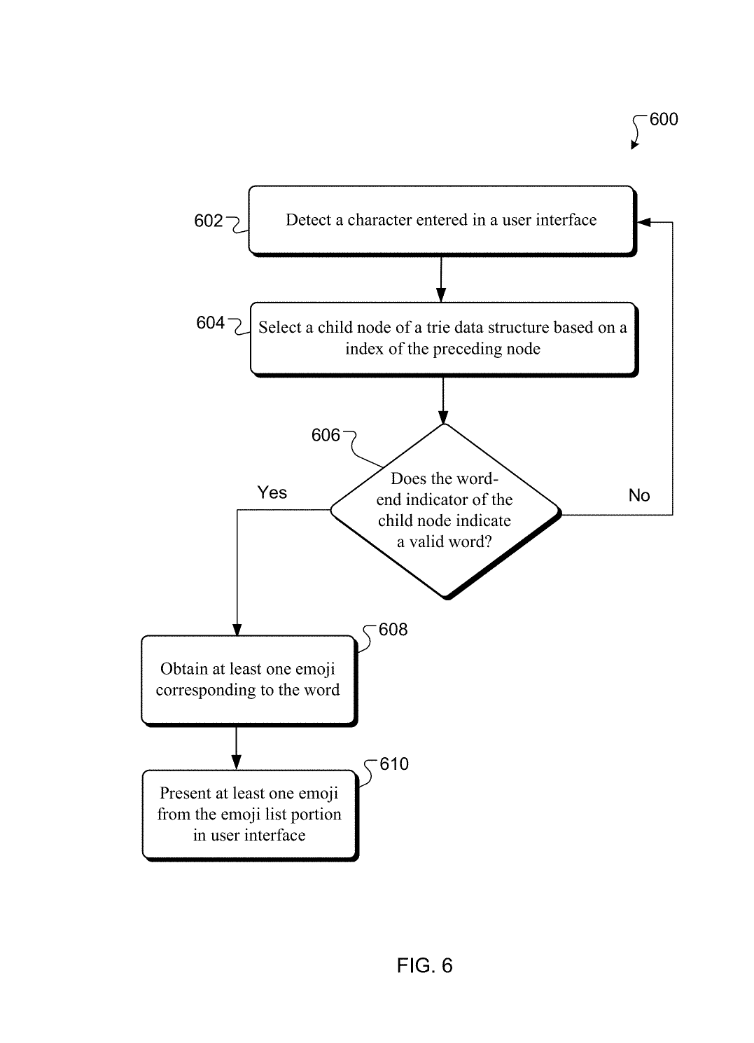

FIG. 6 is a flowchart of an exemplary method 600 for suggesting emojis using trie data structures having integer indices. For ease of discussion, FIG. 6 is discussed together with FIG. 3 in the following. In step 602, the client device 128, 130, 132, or 134 detects one or more characters entered by a user in a user interface 150. In step 604, a processor 146 of the client device selects a first child node of a trie data structure utilizing a children array of integer indices (e.g., trie data structure 300) by starting at index 0 (node 306) and selecting the integer index corresponding to the initial character entered by the user, at step 604.

In step 606, the processor 146 determines whether a string formed by the first character is a valid word, based on the value of the word-end indicator “isEnd.” If, at step 606, the stored value of “isEnd” in the child node equals “False,” indicating that the string is not a valid word, the method 600 returns to step 602. The client device can then detect at least one additional character entered in the user interface 150. If another character is detected, then steps 604 and 606 can be repeated. If, at step 606, “isEnd” equals “True,” then, in step 608, a corresponding list of emojis (stored in “emojiList”) can be obtained in the child node. In step 610, the list of emojis can be presented in the user interface 150 for possible user selection.

Thus, in the example structure 300, the initial character “c” leads to index 1 (node 308), which includes indices for possible second characters “a” and “o.” Note that the word-end indicator “isEnd”=“False” 308c at index 1. If the second character typed by the user is “a,” the processor jumps to index 3 (node 312), which includes indices for possible third characters “r” and “t.” If the third character typed by the user is “r,” the processor jumps to index 4 (node 314), where the value of the word-end indicator “isEnd”=“True” 314c, indicating that the three characters entered by the user form a complete or valid word (“car”) and/or that at least one corresponding emoji is available for presentation. The at least one emoji can be presented via the user interface 150 for possible user selection.

In some instances, the number of words that can be replaced with emojis is significantly less than the number of words in a given language, which can render certain data structures highly sparse. For example, each cell of the static children array used to store children pointers in trie data structures 200a, 200b, and 300 can require storage space. This is a greater concern when most of the cells of the children array are empty or null. For example, in trie data structure 200a, 200b, node 204 has only two child nodes, 208 and 216. In other words, only two cells of the 256-pointer array of node 204 store pointers to child nodes, while 254 of the cells in the children array are null or empty. Thus, approximately 99.22% (i.e., 254/256=0.9922) of the children array is empty, leading to an inefficient use of memory.

In an example implementation, the size of the children array of 256 elements can be reduced in any given node to reduce sparseness and/or memory usage. Specifically, the size of the children array can be dynamically varied according to a possible number of letters than can be entered at a node to form or continue forming a complete or valid word or phrase, or to form or continue forming a word or phrase associated with an emoji. For example, if there are only two possible letters that can be entered to continue forming a complete word or phrase, then the size of the children array can be 2, with one element or cell for each possible letter. In some instances, the size of the children array can increase or decrease as demand increases or decreases, respectively. Demand in this case can be based on a number of byte-index pairs in the array. Each cell of the children array can include an index of a byte of the trie data structure. In one implementation, reducing or eliminating the sparseness of the children arrays in this manner reduced the memory required for storing an emoji mapping dictionary from 15 MB to about 0.5 MB. This was on top of a previous memory reduction from 57 MB to 15 MB achieved with the use of integer indices, as described above. In general, with a dynamic array, a size of the children array for a given node can correspond to a number of child nodes.

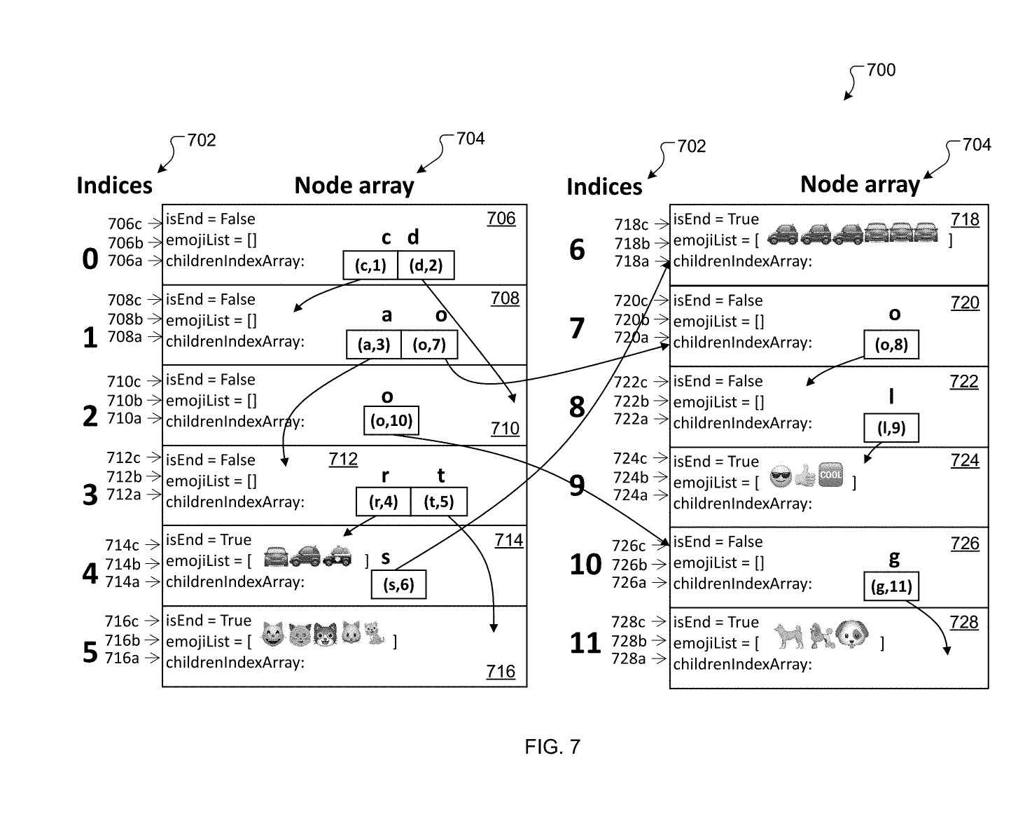

FIG. 7 illustrates an exemplary trie data structure 700 having dynamic children arrays of byte-index pairs. Note that the trie data structure 700 is intended to illustrate the concepts described herein with a small and simple set of words, which is not intended to be limiting. Each node or cell 706-728 of a node array 704 contains a byte-index pair for determining a child node. Thus, instead of containing a larger children array of 256 cells, the number of cells in each children array is reduced to the number of possible child nodes stemming from a given parent node. For example, root node 706 at index 0 refers to two byte-index pairs (c,1) and (d,2) in the children array 706a, which refer to character “c” at index 1 and character “d” at index 2, respectively (e.g., array of two). In this case, the children array 706a can be considered to have an array size of 2, which corresponds to the number of child nodes for node 706. Each element or cell in the children array 706a can include a byte-index pair (e.g., (c,1) or (d,2)).

With the dynamic array approach, each node of the trie structure 700 can include the following elements:
i. childrenDynamicArray: An array having a dynamic array having a byte-index pair including a byte value and an index of the node. The childrenDynamicArray can be referred to herein as a children array. In the exemplary structure 700 of FIG. 7, node 706 has a children array 706a, node 708 has a children array 708a, and so on (e.g., nodes 710-728 have children arrays 710a-728a, respectively).
ii. emojiList: A list of emojis having at least one emoji if the string ending with the current node is a word end or a prefix. In the exemplary structure 700 of FIG. 7, node 706 has an emoji list portion 706b, node 708 has an emoji list portion 708b, and so on (e.g., nodes 710-728 have emoji list portions 710b-728b, respectively).

In this exemplary implementation, each node of the trie data structure 700 further includes:
iii. Word-end indicator: A portion of the node configured to store an indicator having a Boolean value that indicates whether the current node corresponds to a word end. In the exemplary structure of FIG. 7, node 706 has a word-end indicator 706c, node 708 has a word-end indicator 708c, and so on (e.g., nodes 710-728 have word-end indicators 710c-728c, respectively).

The structure 700 can be used as described above in exemplary methods 400, 500, and/or 600. Referring to FIGS. 6 and 7, in step 602 of method 600, for example, the client device 128, 130, 132, or 134 detects one or more characters entered by a user in a user interface 150. In step 604, a processor 146 of the client device selects a first child node of a trie data structure 700 utilizing a dynamic array of byte-index pairs (e.g., structure 700). The exemplary root node 706 is indexed at 0 and has a child index array size of two.

In some implementations, the children array can be sorted by the alphabetical order of the characters (e.g., c before d, etc.). In some implementations, the processor 146 can perform a binary or other suitable search in the dynamic array to locate the appropriate pair. Thus, if the device detects the character “c,” the search would lead to cell (c,1) in the child array 706a of node 706, which would direct the processor to index 1 (node 708). If the device detects an initial character “b,” however, no corresponding byte-index pair would be found at node 706, given that the example trie data structure 700 does not have a word that starts with “b.” In such a case, the method 600 can fail to identify or suggest any emojis that correspond to words beginning with “b”.

In step 606, the processor 146 determines whether a string of one or more characters is a valid word based on the value of word-end indicator “isEnd” and/or existence of at least one emoji in the emoji list portion. If, in step 608, the stored value of “isEnd” in the child node equals “False,” indicating that the string is not a valid word, the method 600 can return to step 602. In step 602, the client device can detect at least one additional character in the user interface 150. If another character is detected, then steps 604 and 606 can be repeated. Continuing the example in which the user is typing “car,” the processor 146 then continues from node 708 and searches for “a.” Finding pair (a,3) at node 708, the processor 146 can jump to index=3 (node 712), according to the byte-index pair. In some implementations, the processor can search the trie data structure at the same time (or nearly the same time) as the user is entering characters. The processor 146 can then search for “r” at node 712 and can find the pair (r,4) which leads to index=4 (node 714). When, at step 606, “isEnd” equals “True” 714c and/or at least one emoji is identified in the emoji list portion 714b, then, in step 608, a corresponding list of emojis (stored in “emojiList”) can be obtained in the child node. In the exemplary structure 700, for example, the node 714 at index 4 has “isEnd=True” 714c, which means that “car” is a complete or valid word. The processor 146 can then search child nodes of node 714 to identify any other possible words that begin with “car” and have at least one emoji. Any additional emoji found from this search can be added to list of emoji identified for the complete word “car,” thereby forming a merged emoji suggestion list. In step 610, the list of emojis can be presented in the user interface 150 for possible user selection.

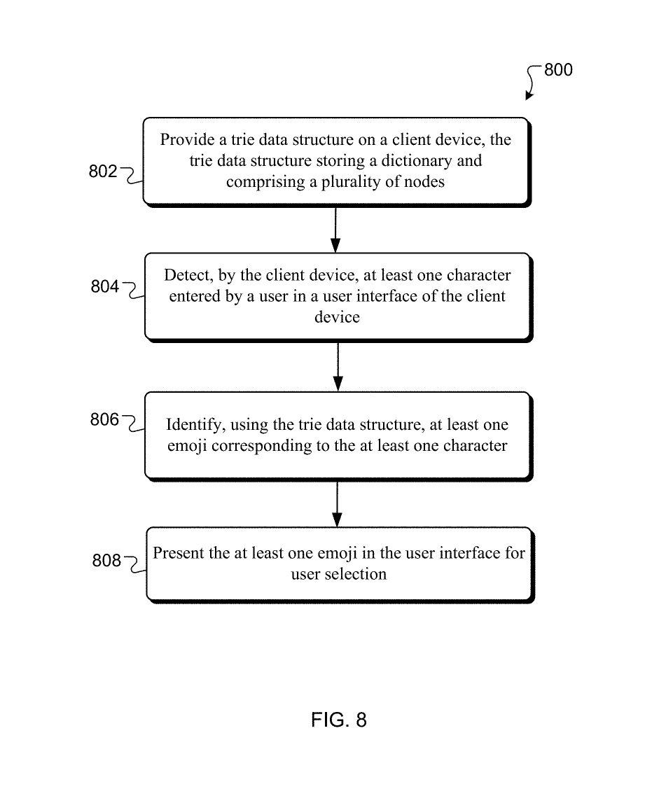

FIG. 8 is a flowchart of an example method 800 for suggesting emojis using a trie data structure. In step 802, a trie data structure, or a portion thereof, is provided on a client device. The trie data structure stores a dictionary and includes a plurality of nodes. At least one node in the trie data structure includes a children array including at least one of: (i) an integer index for identifying a child node, and/or (ii) an array size corresponding to a number of child node for the at least one node. In step 804, the client device can detect at least one character entered by a user in the user interface of the client device. In step 806, at least one emoji corresponding to the character can be identified using the trie data structure. In step 808, at least one identified emoji can be presented in the user interface for the user selection.

In some implementations, each node in a trie structure can be assigned a weight that is used for emoji suggestions. The weight for each node can be obtained, for example, from a language model and/or can be determined based on a history of words, phrases, and/or emojis used by users. In general, the weight for a node can provide an indication of how likely it is that a user will enter characters that reach the node or go through the node. For example, referring again to FIGS. 2A-2B, if a language model and/or a user history indicates that it is more likely that a user will type “car” than “cat,” the node with the letter “r” (i.e., node 210) can be assigned a higher weight than the node with the letter “t” (i.e., node 214). This way, when a user enters “ca,” the systems and methods described herein can consider the weights in the child nodes to predict a next letter to be entered by the user. In this example, given that the weight for “r” is greater than the weight for “t,” the systems and methods can determine that the user is more likely to type “car” than “cat.” Based on this determination, the systems and methods can suggest car emojis rather than cat emojis, for example, once the user enters “ca.” In some instances, the emoji suggestions can rank car emojis higher than cat emojis, for example, by placing car emojis in a more prominent position or at a top of an emoji suggestion list.

Alternatively or additionally, the weights for the nodes can be determined based on a context. For example, when a user begins a message with “I'm going ho,” the systems and methods can use weights to determine that the third word in the message is more likely to be “home” than “horse.” Such word predictions can be based on, for example, a language model that recognizes sentence structure and/or word patterns to predict additional words that are likely to be entered by users. In this example, emoji suggestions related to “home” can be prioritized over emoji suggestions related to “horse.”

In certain instances, the systems and methods can combine weights for multiple nodes to predict a final word or phrase that will be entered by a user. For example, when a user begins a message by entering “c,” the systems and methods can identify a most likely branch in the trie structure for the user's final word or phrase. Referring to FIGS. 2A-2B, for example, the systems and methods can recognize that the final word or phrase can correspond to a first branch ending at node 212, a second branch ending at node 214, or a third branch ending at node 220. To determine a most likely branch for the message, the systems and methods can combine the weights for each node in each branch. In some instances, for example, the node weights for a branch can be added together to determine a total weight for the branch. The branch having the highest combined weight can be identified as the most likely branch for the message. In this way, emojis corresponding to that branch can be suggested first to the user or given a higher priority over emojis corresponding to the other branches.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A memory-efficient computer-implemented method for suggesting emojis in electronic communication, the method comprising:
providing a trie data structure on a client device, the trie data structure storing a dictionary and comprising a plurality of nodes,
wherein at least one node in the trie data structure comprises a children array comprising at least one of:
an integer index for identifying a child node; and
an array size corresponding to a number of child nodes for the at least one node; and
detecting, by the client device, at least one character entered by a user in a user interface of the client device;
identifying, using the trie data structure, at least one emoji corresponding to the at least one character; and
presenting the at least one emoji in the user interface for user selection.

2. The method of claim 1, wherein the children array comprises the integer index for identifying the child node.

3. The method of claim 2, wherein the children array comprises a plurality of cells, and wherein the cells comprise a plurality of integer indices identifying a plurality of child nodes.

4. The method of claim 1, wherein the children array comprises the array size corresponding to the number of child nodes for the at least one node.

5. The method of claim 4, wherein the children array comprises at least one pointer for identifying at least one child node.

6. The method of claim 4, wherein the children array comprises the integer index for identifying the child node.

7. The method of claim 1, wherein identifying the at least one emoji comprises:
selecting a child node corresponding to the at least one character; and
determining that the child node comprises at the least one emoji.

8. The method of claim 7, wherein selecting the child node comprises:
detecting, by the client device, at least one additional character entered in the user interface; and
advancing from a parent node to the child node based on the at least one additional character.

9. The method of claim 1, wherein the at least one character forms a prefix to at least two words, and wherein identifying the at least one emoji comprises:
determining at least two child nodes, of the trie data structure, corresponding to the at least two words, each node of the at least two child nodes comprising a corresponding emoji list; and
compiling two or more emojis from the corresponding emoji lists to define the at least one emoji.

10. The method of claim 1, further comprising:
receiving a user selection of an emoji from the at least one emoji; and
presenting the selected emoji on the user interface.

11. A system for suggesting emojis in electronic communication, the system comprising:
one or more computer processors programmed to perform operations comprising:
providing a trie data structure on a client device, the trie data structure storing a dictionary and comprising a plurality of nodes,
wherein at least one node in the trie data structure comprises a children array comprising at least one of:
an integer index for identifying a child node; and
an array size corresponding to a number of child nodes for the at least one node; and
detecting, by the client device, at least one character entered by a user in a user interface of the client device;
identifying, using the trie data structure, at least one emoji corresponding to the at least one character; and
presenting the at least one emoji in the user interface for user selection.

12. The system of claim 11, wherein the children array comprises the integer index for identifying the child node.

13. The system of claim 12, wherein the children array comprises a plurality of cells, and wherein the cells comprise a plurality of integer indices identifying a plurality of child nodes.

14. The system of claim 13, wherein the children array comprises the array size corresponding to the number of child nodes for the at least one node.

15. The system of claim 14, wherein the children array comprises the integer index for identifying the child node.

16. The system of claim 11, wherein identifying the at least one emoji comprises:
selecting a child node corresponding to the at least one character; and
determining that the child node comprises at the least one emoji.

17. The system of claim 16, wherein selecting the child node comprises:
detecting, by the client device, at least one additional character entered in the user interface; and
advancing from a parent node to the child node based on the at least one additional character.

18. The system of claim 11, wherein the at least one character forms a prefix to at least two words, and wherein identifying the at least one emoji comprises:
determining at least two child nodes, of the trie data structure, corresponding to the at least two words, each node of the at least two child nodes comprising a corresponding emoji list; and
compiling two or more emojis from the corresponding emoji lists to define the at least one emoji.

19. The system of claim 11, the operations further comprising:
receiving a user selection of an emoji from the at least one emoji; and
presenting the selected emoji on the user interface.

20. An article for suggesting emojis in electronic communication, the article comprising:
a non-transitory computer-readable medium having instructions stored thereon that, when executed by one or more computer processors, cause the computer processors to perform operations comprising:
providing a trie data structure on a client device, the trie data structure storing a dictionary and comprising a plurality of nodes,
wherein at least one node in the trie data structure comprises a children array comprising at least one of:
an integer index for identifying a child node; and
an array size corresponding to a number of child nodes for the at least one node; and
detecting, by the client device, at least one character entered by a user in a user interface of the client device;
identifying, using the trie data structure, at least one emoji corresponding to the at least one character; and
presenting the at least one emoji in the user interface for user selection.
